(19) United States
(12) Patent Application Publication
(10) Pub. No.: US 2009/0177624 A1
(43) Pub. Date: Jul. 9, 2009

(54) SYSTEM AND METHOD FOR PEER-TO-PEER CONTACT INFORMATION LOOK-UP

(76) Inventor: Eskil Gunnar Ahlin, Veberod (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/970,077

(22) Filed: Jan. 7, 2008

(51) Int. Cl. G06F 17/30

(52) U.S. Cl. 707/3; 707/E17.014

(57) ABSTRACT

The present invention provides a system and method for providing a peer-to-peer contact information look-up system. A user who seeks contact information may enter an identification query, such as a name or other identifier. A first level search may be performed by determining whether any contacts contained in the user's electronic address book satisfy the query. If the contact is not found in the user's personal electronic address book, then the query may be transmitted to a plurality of other participant electronic devices in the system, thereby initiating a second level search. The devices that receive the query in the second level search may then search their personal electronic address books for the contact. If the contact is identified, the contact information is sent to the user device from which the query was initiated. If, however, none of the second level devices can identify the contact, each of the second level participant devices may transmit the query to a plurality of other participant devices in the system, thereby initiating a third level search. The personal address books of each of the third level devices are searched for the contact, and so on until the contact is found or the search terminates.

### TECHNICAL FIELD OF THE INVENTION

The technology of the present disclosure relates generally to portable electronic devices, and more particularly to a system and method by which portable electronic devices may be used to provide peer-to-peer contact information look-up.

### DESCRIPTION OF THE RELATED ART

Portable electronic devices commonly are equipped with electronic address books containing names, telephone numbers, physical addresses, email addresses, and other contact information for individuals and entities. By maintaining an electronic address book, a user of a portable electronic device may avoid the inconvenience of having to carry a conventional paper telephone book. If contact information for a given person or entity is not contained within the user's device, the user may resort to searching a large centralized electronic directory, such as a web-based or network directory. Centralized directories, however, may be inconvenient for a user to access and expensive for service providers to maintain.

Portable electronic devices, such as mobile telephones, media players, personal digital assistants (PDAs), lap tops, and others, are ever increasing in popularity. Portable electronics provide various means of communication. In addition to conventional telephone calls, many devices may be capable of email communication, instant messaging, video and picture messaging, and perhaps others. Given the various communication methods, it is important for users to have convenient and prompt access to contact information for those with whom a user may wish to communicate.

One method of accessing contact information is through the use of a personal electronic address book. The user may store contact information of others within a memory in the portable electronic device. As stated above, the contact information may include a name and physical address, as well as one or more telephone numbers, email addresses, instant messaging addresses, and so on. Personal address books, however, are limited typically to persons and entities with which the user is familiar. As to those whom a user contacts infrequently, or has never contacted, the personal address book may be unlikely to contain the desired contact information.

If a personal electronic address book does not contain the desired contact information, one option is for the user to access a centralized electronic directory. Examples of centralized directories include web-based “yellow pages” style directories and similar networked directories. Centralized directories, however, also may be deficient. Although centralized directories may contain a substantially larger scope of contacts than a personal address book, such large scope tends to render the directories difficult to keep up to date. When individuals and entities change contact information, it may take a considerable amount of time for a centralized directory to be notified and the contact information amended. Centralized directories also can be expensive to maintain, and lack contact information for users who are not registered with the directory's provider.

Centralized directories also may present inconveniences for a user, particularly if the user electronic device is a mobile telephone. For example, a user often has to log onto a network service through a web page or other network database before inputting a search query for contact information. Access to certain directories also may require a mobile telephone user to pay additional fees for network or Internet access or directory services.

### SUMMARY

To improve the consumer experience with electronic devices, there is a need in the art for an improved system and method for accessing contact information for communication with a portable electronic device. In exemplary embodiments, multiple users participate in a peer-to-peer contact information look-up system. Each participant maintains a personal electronic address book within a portable electronic device. Each address book also may be assigned a public URL (Uniform Resource Locator), such an HTTP URL, SIP URL, or others as are known in the art.

A user who seeks contact information may enter an identification search query, such as a name or other identifier. A first level search may be performed by determining whether any contact contained in the user's electronic address book satisfies the query. If the contact is not found in the user's personal electronic address book, then the query may be transmitted automatically to the URL locations of a plurality of other participant devices in the system, thereby initiating a second level search. The devices that receive the query in the second level search may then search their personal electronic address books for the contact. If the contact is identified, the contact information is sent to the user who initiated the query. If, however, none of the second level devices can identify the contact, each of the second level participant devices may transmit the query to a plurality of other participants in the system, thereby initiating a third level search. The personal address books of each of the third level devices are searched for the contact, and so on until the contact is found or the search terminates.

In this manner, a peer-to-peer system linking individual address books substitutes for a centralized directory. Because the individual address books represent small components and are user controlled, they are easier to update and cost essentially nothing to maintain. Maintenance is essentially free and simple because each individual user needs to maintain only that user's own address book. In addition, computing resources are distributed to provide better management of system resources. In addition, the accuracy is enhanced because the search radiates from the user in associated “rings” of search levels, rather than be processed by a centralized device that may have no specific relationship to the user.

Therefore, according to one aspect of the invention, an electronic device comprises an input device and a controller. The controller is configured to receive a contact search query from the input device and transmit the search query to at least one other electronic device. The controller is further configured to receive contact information satisfying the search query from at least one other electronic device.

According to one embodiment of the electronic device, the controller is configured to transmit the contact search query to a plurality of other electronic devices and receive the contact information from one of the plurality of other electronic devices.

According to one embodiment of the electronic device, the electronic device further comprises an address book containing contact information for at least one contact. The controller is further configured to search the address book to determine whether a contact within the address book satisfies the contact search query, and if no such contact is found, transmit the contact search query to at least one other electronic device.

According to one embodiment of the electronic device, the controller is further configured to receive a contact search query from at least one other electronic device and search the address book to determine whether a contact satisfies the received search query. If the controller determines that a contact satisfies the received search query, the controller is further configured to transmit the contact information to the electronic device that sent the received search query. If the controller determines that no contact satisfies the received search query, the controller is further configured to transmit the received search query to at least one additional electronic device.

According to one embodiment of the electronic device, the address book includes an associated URL (Uniform Resource Locator) to provide an identifier for receiving a search query or contact information satisfying a search query.

According to one embodiment of the electronic device, the electronic device is a mobile telephone.

According to another aspect of the invention, a contact information look-up system comprises a user electronic device comprising an input device and a user controller, wherein the user controller is configured to receive a contact search query from the input device and transmit the search query to at least one participant electronic device. At least one participant electronic device comprises an address book containing contact information for at least one contact and a participant controller, wherein the participant controller is configured to receive the search query from the user electronic device and search the address book to determine whether a contact satisfies the search query. If the participant controller determines that a contact satisfies the search query, the participant controller is further configured to transmit the contact information to the user electronic device. If the participant controller determines that no contact satisfies the search query, the participant controller is further configured to transmit the search query to at least one other participant electronic device.

According to one embodiment of the system, the user electronic device further comprises a user address book containing contact information for at least one contact, and the user controller is further configured to search the user address book to determine whether a contact within the user address book satisfies the search query.

According to one embodiment of the system, each address book includes an associated URL (Uniform Resource Locator) to provide an identifier for receiving the search query.

According to one embodiment of the system, the user controller is configured to transmit the search query to a plurality of participant electronic devices.

According to one embodiment of the system, if the participant controllers of the plurality of participant electronic devices determine that no contact satisfies the search query, the participant controllers are further configured to transmit the search query to a plurality of other participant electronic devices.

According to one embodiment of the system, the participant electronic devices comprise a plurality of search levels, wherein each participant electronic device is at a search level based on the number of times the search query has been forwarded in a pathway from the user electronic device to the participant electronic device. The number of search levels is limited to a fixed number.

According to one embodiment of the system, the user electronic device is a mobile telephone.

According to one embodiment of the system, each participant electronic device is a mobile telephone.

Another aspect of the invention is a method of obtaining contact information with a user electronic device comprising the steps of inputting a search query into the user electronic device, forwarding the search query to at least one participant electronic device having an address book containing contact information for at least one contact, and searching the address book to determine whether a contact satisfies the search query. If a contact satisfies the search query, the contact information is transmitted to the user electronic device; else if no contact satisfies the search query, the search query is forwarded to at least one other participant electronic device.

According to one embodiment of the method, the method further comprises displaying the contact information for a contact that satisfies the search query.

According to one embodiment of the method, the user electronic device has a user address book containing contact information for at least one contact, and the method further comprises searching the user address book to determine whether a contact satisfies the search query.

According to one embodiment of the method, the search query is forwarded from the user electronic device to a plurality of participant electronic devices.

According to one embodiment of the method, if a search of the address book of each participant electronic device determines that no contact satisfies the search query, then each participant electronic device forwards the search query to a plurality of other participant electronic devices.

According to one embodiment of the method, each participant electronic device is at a search level based on the number of times the search query has been forwarded between the user electronic device and the participant electronic device. The method further comprises terminating the search after the search query has been forwarded over a specific number of search levels.

According to one embodiment of the method, steps of forwarding the search query include adding pathway information indicating the transmission pathway of the search query from the user electronic device to a participant electronic device.

According to one embodiment of the method, the step of transmitting the contact information to the user electronic device includes transmitting the contact information along a reverse pathway from the participant electronic device containing the contact information to the user electronic device.

According to one embodiment of the method, the step of transmitting the contact information to the user electronic device includes removing the pathway information as the contact information is transmitted along the reverse pathway.

According to one embodiment of the method, each address book includes an associated URL (Uniform Resource Locator) to provide an identifier for receiving the search query, and the steps of forwarding the search query comprise forwarding the search query based on the address book URLs.

According to one embodiment of the method, the step of inputting the search query comprises entering search criteria to limit the contact information received from a participant electronic device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device for use in accordance with an embodiment of the present invention.

FIG. 2 is a schematic block diagram of operative portions of the mobile telephone of FIG. 2.

FIG. 3 is an exemplary graphical user interface for displaying address book content on the mobile telephone of FIG. 1 in accordance with an embodiment of the present invention.

FIG. 4 is an exemplary graphical user interface for displaying contact information from an address book on the mobile telephone of FIG. 1 in accordance with an embodiment of the present invention.

FIG. 5 is a schematic diagram of a communications system in which the mobile telephone of FIG. 1 may operate.

FIG. 6 is a flowchart depicting an exemplary method by which a user may obtain contact information in accordance with an embodiment of the present invention.

FIGS. 7 and 8 are flows charts depicting additional details about the stages of the method of FIG. 6.

FIG. 9 is a schematic diagram depicting an exemplary pathway of a search query and response in accordance with an embodiment of the present invention.

FIG. 10 is a schematic diagram depicting an exemplary search tree in accordance with an embodiment of the present invention.

FIGS. 11 and 12 are exemplary graphical user interfaces for entering a contact search query in accordance with embodiments of the present invention.

### DETAILED DESCRIPTION OF EMBODIMENTS

The present invention provides a user of a portable electronic device with an improved system and method for accessing contact information for communication with others. In exemplary embodiments, a plurality of users participates in a peer-to-peer contact information look-up system. Each user maintains a personal address book within an electronic device, which may be a portable electronic device such as a mobile telephone. Each participant device's address book may be assigned a public URL (Uniform Resource Locator), such as an HTTP URL, SIP URL, or others as are known in the art. As is further described below, each participant device's URL may provide a means for receiving an incoming look-up search query for contact information.

A user of the system may possess a portable electronic device with communication capabilities, such as, for example, telephone calling, emailing, instant messaging, video or picture messaging, or others. Stored within the portable electronic device may be a personal electronic address book containing contact information regarding others with whom the user may desire to communicate. The contacts may include individuals, entities, and groups thereof, and the contact information may include names, physical addresses, telephone numbers, email addresses, instant messaging addresses, etc.

In addition, for each contact in an address book who also is a member of the peer-to-peer look-up system, the contact information also may include a URL for each such contact's own address book. The address book URLs may be used to provide search links among the various address books of the participants in the system.

A user who seeks contact information may enter an identification query, such as a name or other identifier, into the user's electronic device. Initially, a search may be made within the user's personal address book within the electronic device, providing a first level search. If the contact is not found in the user's personal electronic address book, the query then may be transmitted automatically to a plurality of other participants in the system to initiate a second level search. Specifically, the search query may be transmitted to one or more contacts within the user's personal address book for which there is an associated address book URL.

The devices associated with the URLs of the second level search may receive the search query. Each of the second level devices may then search its stored electronic address book for a contact satisfying the search query. If the contact is identified, the contact information is sent to the URL of the address book of the user who initiated the search. If, however, none of the second level devices can identify the contact, each of the second level devices then may transmit the query to one or more additional participant devices in the system, thereby initiating a third level search.

The third level devices are selected from URLs contained in the contact information of one or more contacts within the second level address books. Each third level device may search its stored electronic address book for a contact meeting the search query. If the contact is identified, the contact information is transmitted back through the search pathway to the initial user. If a contact is not found, then the search query may be forwarded to a fourth level, and so on until either the contact is found, or the search is terminated by defined limitation criteria.

It will be appreciated the number of searched devices may grow exponentially across the search levels, thereby increasing the likelihood that the subject contact of the query may be identified. In this manner, users of the system link their individual address books into a substantial peer-to-peer system of contact information without requiring a centralized directory. Because the individual address books represent small components and may be user controlled, they are easier to update and cost essentially nothing to maintain.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or a desktop or laptop computer. For purposes of the description herein, the interchangeable terms “electronic equipment” and “electronic device” also may include portable radio communication equipment. The term “portable radio communication equipment,” which sometimes herein is referred to as a “mobile radio terminal,” includes all equipment such as mobile telephones, pagers, communicators, electronic organizers, personal digital assistants (PDAs), smartphones, and any communication apparatus or the like.

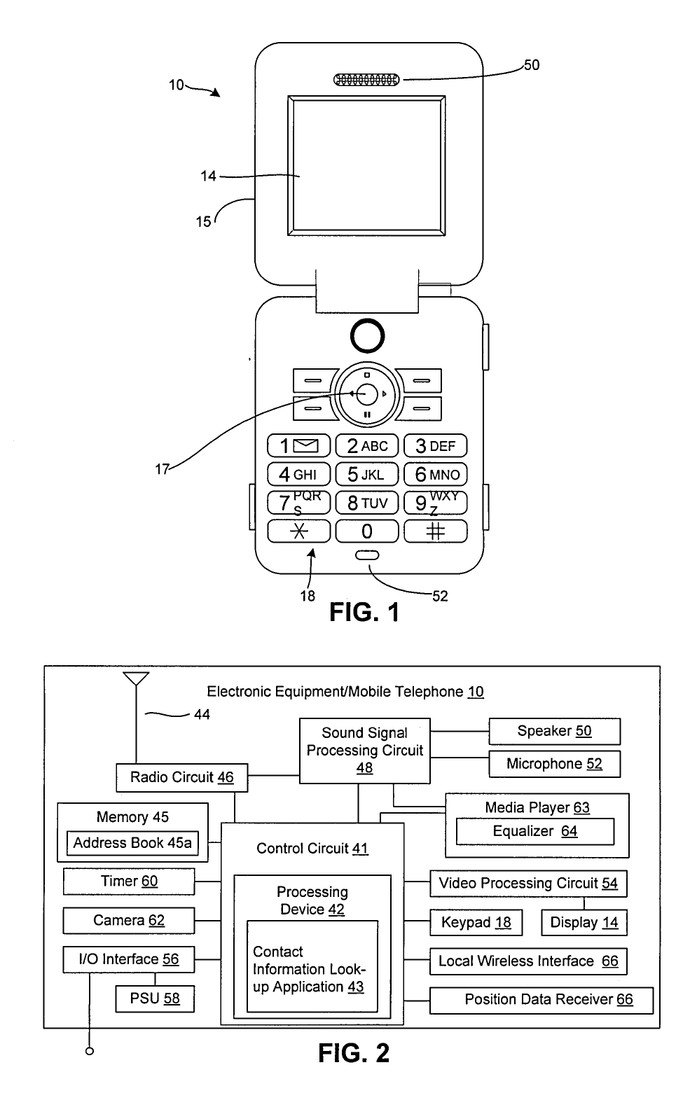

FIG. 1 depicts an exemplary mobile telephone 10. Mobile telephone 10 may be a clamshell phone with a flip-open cover 15 movable between an open and a closed position. In FIG. 1, the cover is shown in the open position. It will be appreciated that mobile telephone 10 may have other configurations, such as a “block” or “brick” configuration.

FIG. 2 represents a functional block diagram of the mobile telephone 10. The mobile telephone 10 may include a contact information look-up application 43 for carrying out the features of the invention. Application 43 may be embodied as executable program code that is resident in and executed by the mobile telephone 0O. The mobile telephone 10 may include a controller that executes the program code stored on a computer or machine-readable medium. The controller may include a control circuit 41 and/or a processing device 42. The program may be a stand-alone software application or form a part of a software application that carries out additional tasks related to the mobile telephone 10.

The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages, often referred to as “SMS” (which stands for short message service) messages. The mobile telephone 10 also may configured to transmit, receive, and/or process electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in a memory 45, executing applications to allow user interaction with data, displaying video and/or image content associated with the data, outputting audio sounds associated with the data and so forth.

FIG. 2 also depicts an address book 45a stored within the memory 45 of the mobile telephone 10. The address book may contain contact information for a variety of individuals, entities, and groups thereof. The contact information may include names, other identifiers, telephone numbers (land line and mobile), physical addresses, email addresses, instant messaging addresses, and so on. Although the address book is shown as being part of the memory 45, it will be appreciated that the address book may be stored independent of the memory 45 as a separate component within the mobile telephone. In addition, the address book may be stored external to the mobile telephone and accessible over a wired or wireless interface.

Referring to FIGS. 1 and 2, mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from the memory 45.

A keypad 18 provides for a variety of user input operations. For example, keypad 18 typically includes alphanumeric keys for allowing entry of alphanumeric information such as telephone numbers, phone lists, contact information, notes, etc. In addition, keypad 18 typically includes special function keys 17 such as a “send” key for initiating or answering a call, and others. The special function keys 17 may also include various keys for navigation and selection operations to access menu information within the mobile telephone 10. As shown in FIG. 1, for example, the special function keys may include a five-way navigational ring containing four directional surfaces and a center button that may be used as an “enter key” selection button. Some or all of the keys may be used in conjunction with the display as soft keys. Keys or key-like functionality also may be embodied as a touch screen associated with the display 14.

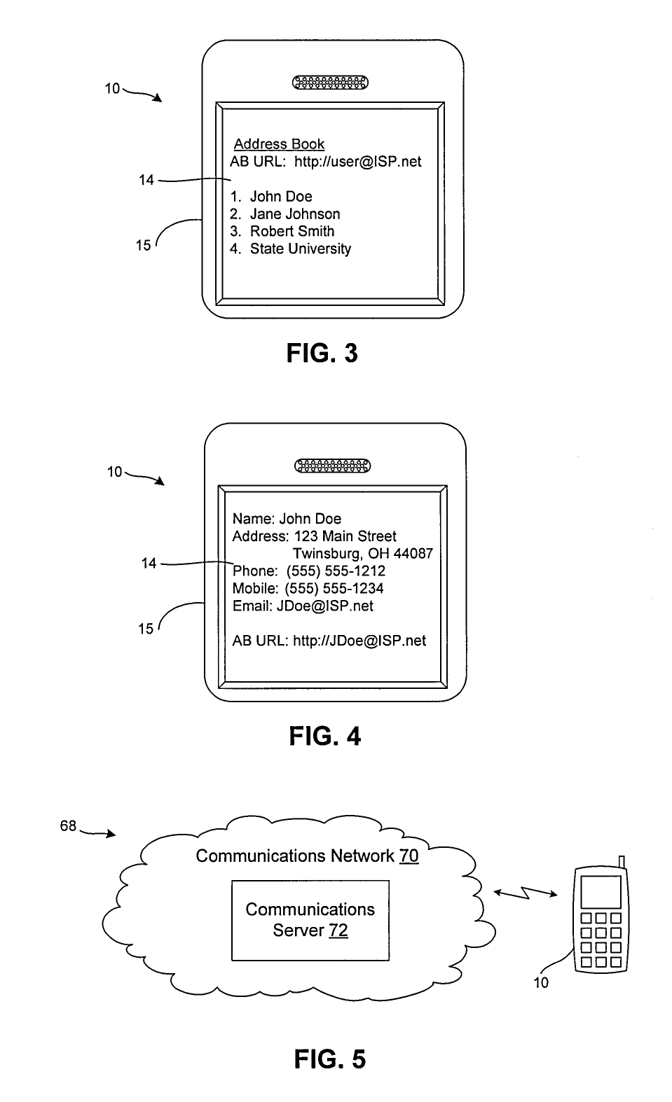

FIG. 3 depicts an exemplary graphical user interface for an electronic address book listing as may be displayed on the mobile telephone 10. It will be appreciated that the form of the interface is an example and may be varied. A user may enter the address book through a conventional menu system or dedicated key input. In this example, the address book contains four entries, three individuals and an entity. The user may navigate about the entries and select a particular entry using buttons on the keypad 18, such as the navigational ring 17.

FIG. 4 depicts exemplary contact information for the first contact in the address book, John Doe. Again, FIG. 4 is an example, and the precise content and appearance of the contact information may vary. The contact information may be entered manually by the user with keypad 18, downloaded from a directory, extracted from an email or other message, or by other means. As shown in this example, the contact information may include a name, physical address, land and mobile telephone numbers, and an email address. Other information may be included as well.

In this embodiment, John Doe is a participant in the peer-to-peer contact information look-up system of the present invention. The contact information for John Doe, therefore, also includes an Address Book (AB) URL, http://JDoe@ISP.net. As further described below, the AB URL is a URL associated with an address book contained within an electric device owned or operated by John Doe. In this example, the URL is of the known “http” form, although the URL may be any form such as “https”, “SIP”, or others as or known in the art or may become available. As further described below, the AB URL provides a mechanism for sending a search query to John Doe's electronic device for searching John Doe's address book for contacts and corresponding contact information. Other participants in the phonebook look-up system (including the initial user as shown in FIG. 3) likewise each may have an AB URL associated with their corresponding electronic address books.

Referring to FIG. 5, the mobile telephone 10 may be configured to operate as part of a communications system 68. The system 68 may include a communications network 70 having a communications server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software. As further described below, the communications network 68 may be used to transmit search queries and contact information among users of the peer-to-peer contact information lookup system of the present invention.

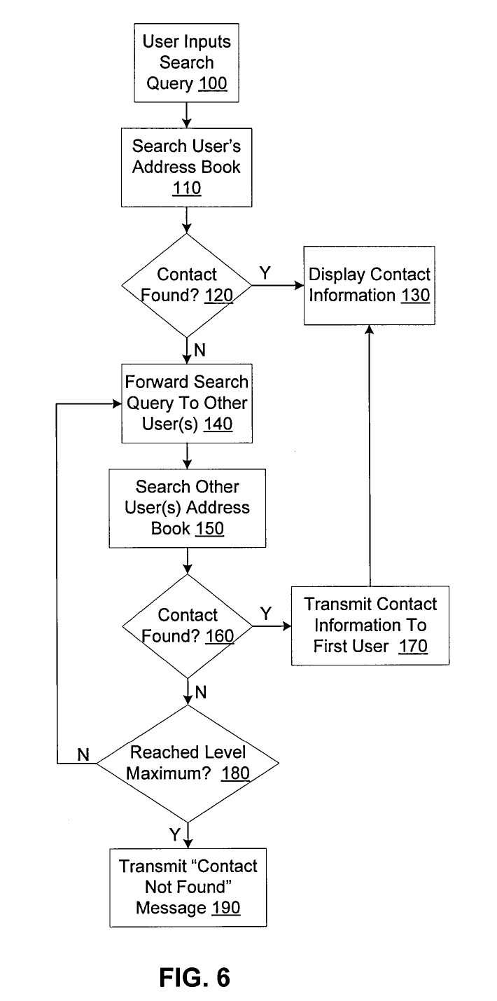

FIG. 6 depicts an exemplary method by which a user may obtain contact information via a peer-to-peer look-up system in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

Referring to FIG. 6, the method begins at step 100 at which a user inputs a contact search query into the user's own electronic device, such as a mobile telephone. The search query may be entered using a keypad or by other conventional means. Although the search query may take a variety of forms, for purposes of this example it is assumed that a user enters a name or other identifier as the search query, and the desired results comprise contact information such as an address, telephone number(s), email address, and the like. At step 110, the address book contained within the user's own electronic device may be searched as a first level search. At step 120, a determination is made as to whether the contact is contained within the user's address book, and if the contact is found, the contact information may be displayed on the user's electronic device at step 130.

If the contact is not one which has been entered into the initial user's electronic address book, then at step 140 the search query is forwarded to one or more other participants in the peer-to-peer network. As stated above, one or more contacts within the initial user's address book may also be a participant in this peer-to-peer system (see, e.g., FIG. 4). The contact information of each participant may contain an Address Book (AB) URL. The AB URL may be associated with the corresponding participants' own electronic address books. In this manner, the initial search query may be transmitted to the other participants based on the AB URLs. For example, the contact John Doe may have an AB URL, such as http://JDoegISP.net. A search query, therefore, may be forwarded to John Doe's electronic device using the AB URL. At step 150, the other participants' electronic devices may execute the search query to search their electronic address books for the desired contact, comprising a second level search. At step 160 a determination is made as to whether the contact is contained or found within one of the second level address books. If the contact is found, at step 170 the contact information may be transmitted back to the initial user and displayed on the initial user's electronic device. For example, the contact information may be transmitted back to the initial user via the initial user's own AB URL.

If the contact is not found in any of the second level electronic address books, at step 180 a check is made as to whether the maximum search level has been reached. As will be described in more detail below, the maximum number of search levels may be capped to prevent the exhaustion of the system resources and to end the search if the contact is not found. If at step 180 the maximum search level has been reached and the contact has not been found, a “contact not found” message may be transmitted back to the initial user. If the maximum search level has not been reached, then the method may return to step 140 to forward the query to a next group of participant electronic devices. A third level search may then be performed at steps 150 and 160 in comparable manner as done at the previous level. The process may repeat until the contact is found or the maximum number of search levels has been exhausted.

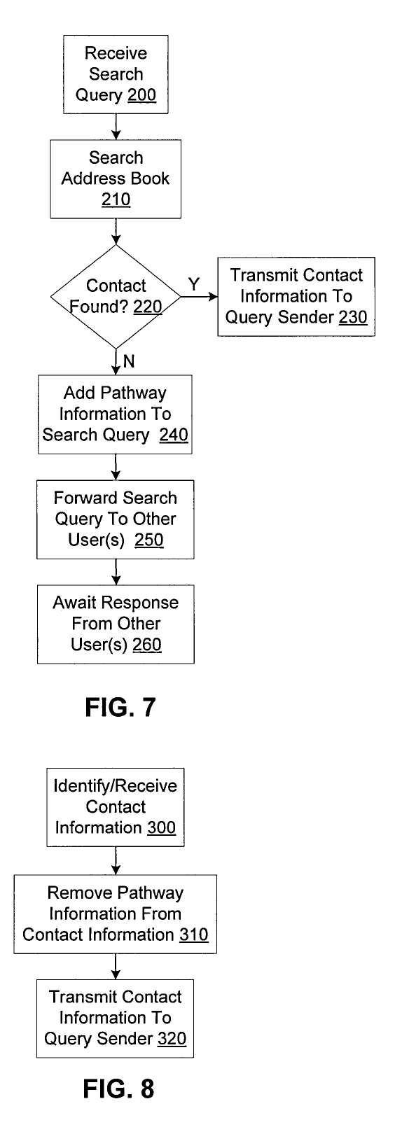

FIG. 7 depicts a method of the performance of a device specifically receiving a search query as part of the method of FIG. 6. At step 200, the device receives a search query. If the device is the initiating device, the query may be inputted directly. Otherwise, the search query may be received from another device within the system. At step 210, the device may search an internal address book for a contact satisfying the search query. If such a contact is found at step 220, the contact information may be transmitted to the device that sent the query (or displayed per FIG. 6 if the device initiated the search). If the contact is not found, at step 240 the device may add pathway information, as further described below, and at step 250 may forward the search query to one or more other devices in the system. At step 260, the device may await any response.

FIG. 8 depicts a method of the performance of a device responding to a search query as part of the method of FIG. 6. At step 300, the device may indentify contact information satisfying the search query within its own address book. Alternatively, the device may receive such contact information from another participant device as part of a transmission pathway back to the initial user. As further described below, at step 310 the device's pathway information is removed, and at step 320 the contact information may be transmitted to the query sender, which may be the initial user or another device within the transmission pathway.

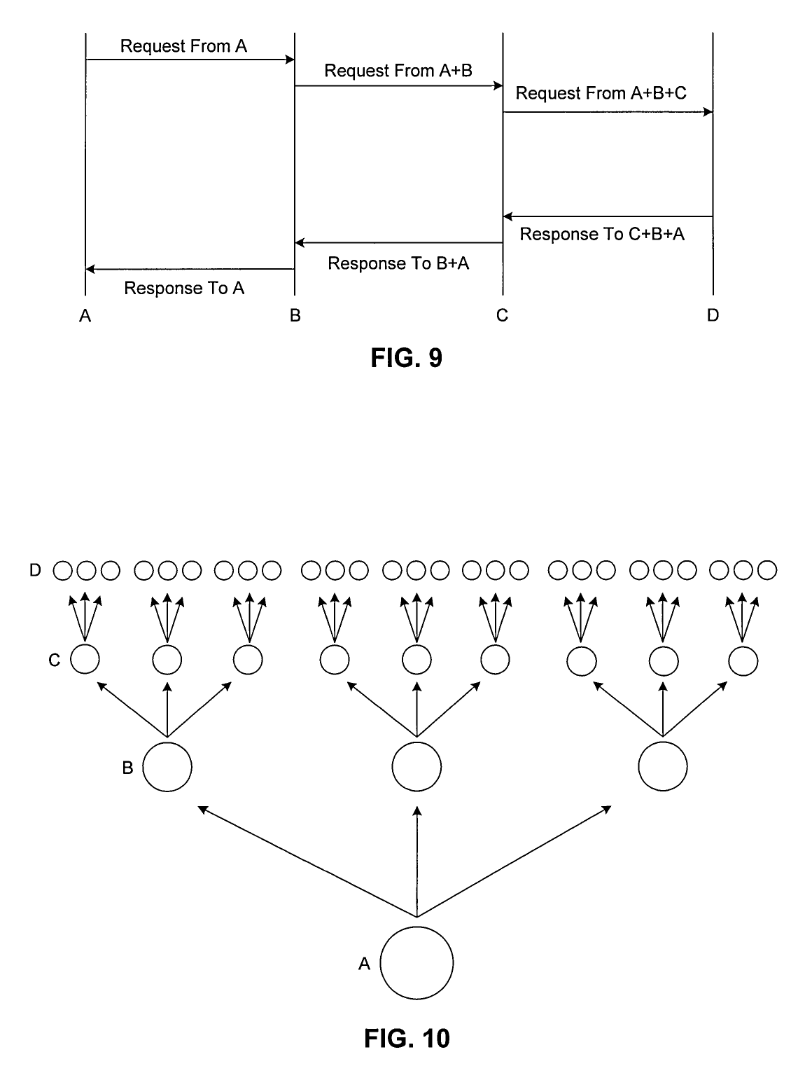

FIG. 9 depicts a linear search progression in which four search levels are performed before the desired contact is located. The top three arrows represent the forwarding pathway of the search query. Line A represents the first level search performed by the initial user's electronic device, line B represents a second level search, line C represents a third level search, and line D represents a fourth level search. The search query is forwarded each time the contact is not found within a given search level. In exemplary embodiments, each forwarded search query includes pathway information as to the transmission path from the previous device or devices. For example, as depicted in the figure, a fourth level device at level D may receive within the forwarded query information corresponding to A+B+C indicating the pathway of the search query. The inclusion of pathway information permits transmission of the contact information, when found, back to the initial user.

Also referring to FIG. 9, in this example the contact is contained in an address book within a fourth level searched device. The bottom three arrows represent the transmission of the contact information from the fourth level (D) back to the initial user. In exemplary embodiments, at each response level the pathway information is removed. For example, the second level device at level B contains its own and A's pathway information (represented as A+B), and no longer contains the pathway information of levels C and D. In this manner, participants in the system, who essentially have agreed to open their address books to search by others, may be assured a certain level of anonymity. For example, as shown in FIG. 7, the initial user at level A receives the desired contact information without having the response pathway information, so user A will not be able to identify the participants at levels B, C, and D along the response pathway. The removal of pathway information also permits a receiving device to determine if it is the initial user who originated the query. If contact information contains pathway information, a device recognizes that the contact information should be forwarded to the next device in the response pathway. The final device in the response pathway may recognize that no pathway information is present, indicating that the device initiated the search. The contact information may then be displayed.

In an alternative embodiment, the search request does not contain pathway information. Rather, the search request contains only the query, the AB URL of the receiving device, and the search level counter. When a match of the query is found, the contact information may be sent directly to the user electronic device, or along a pathway that is not necessarily a reverse of the search pathway.

In preferred embodiments, the search query may be forwarded to multiple users rather than along a single pathway. In this manner, the breadth of the search may be increased by forwarding the search query in a search “tree”. For example, FIG. 10 depicts a search tree comprising four search levels (again represented as A, B, C, and D) in which each participant electronic device forwards the search query to three additional participant devices. Each circle represents an individual participant device. FIG. 9 may be considered to be one branch pathway within the tree of FIG. 10. It will be appreciated that both the number of queries forward by each device and the number of search levels may be varied. In the example of FIG. 10, if the contact is not found at a given search level, each participant device forwards the search query to three other participant devices. At the fourth level, therefore, 27 devices execute the search query, and the total number of searched devices, including the initial user, is 40 (27+9+3+1).

It can be seen, therefore, that the total number of searched address books grows exponentially with each search level. For example, if the tree depicted in FIG. 10 were expanded to eight levels, the total number of searched devices across all levels (including the initial user's device) would be 3280. The total number “T” of searched device address books may be generalized to the formula:

$$T = {\sum }_{i = 1}^{n} {x}^{( n - 1 )} , i = 1 to n , where x is the number queries forwarded by each device and n is the number of levels . \qquad Eq . 1$$

The number of searched address books thus may grow rapidly over the search levels, thereby increasing the likelihood that the contact may be identified. The formula number represents a maximum. For example, if a given participant has his device powered off, the address book of that device may not be searched, and nor may that device forward the query. The exponential nature of the search tree tends to overcome deficiencies that may exist when not all the devices are participating. The exponential nature of the search tree, however, may have a negative impact for system and network resources if the search is permitted to continue indefinitely. Accordingly, as referenced above with respect to the method of FIG. 6 (step 180), the system may be configured to cap the number of search levels to end the search if the contact is not found. The example described above, in which each device forwards the search query to a maximum of three other devices across a maximum of eight levels, may represent for many systems a proper balance between search efficacy and system resources, although the precise numbers may be varied depending upon the circumstances.

In an alternative embodiment, the initial user's device need not have a personal address book. In this embodiment, the first level search is skipped and the search query may be transmitted immediately to other participant devices in the peer-to-peer network.

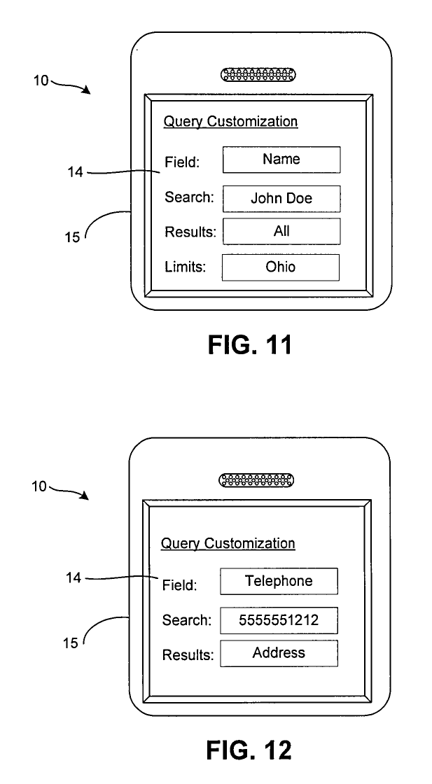

The peer-to-peer contact information look-up system may be accessed using any conventional menu or operation selection mechanism. In one embodiment, a user may simply enter a search query, and the query may be processed as described above. To enhance the efficacy of the system, however, a user may prefer a customized search. FIG. 11 depicts an exemplary graphical user interface for obtaining contact information using a customized query. The indicators (Field, Search, etc.) represent fields to customize a query, and the boxes represent data that may be inputted by a user, such as with the keypad of the electronic device. In the example of FIG. 11, the user has entered “Name” into the Field box, indicating that the user intends to search by name. The “Search” box contains the actual query, “John Doe” in this example. The “Results” box may provide a user with options for limiting the results. In this example, the user has entered “All”, indicating that the results will comprise the entire contact information available as to John Doe. The “Limits” box may permit a user to provide a more targeted search. In this example, the user has entered “Ohio” as a limit, which means that if multiple people with the same name exist, a preference in the results may be made for a John Doe living in or otherwise associated with Ohio.

The “Limits” field also may provide a more targeted search by resulting in a preference as to which participant devices will receive the forwarded search query for the second level search. For example, suppose the user's address book includes five participants in the system, each associated with an Address Book (AB) URL. Under the system configuration, however, the query may be forwarded to a maximum of only three other devices. The prescribed “Limits” may be used to select which among the five participant AB URLs will receive the query. For example, the three participant devices located within or closest to Ohio may receive the query. Of course, this may occur automatically without any additional input by the user. The Limits preference may carry through the additional search levels as well.

FIG. 12 depicts another example of a graphical user interface for providing a customized search query. In this example, the user has entered “Telephone” into the “Field” box, indicating that the user intends to search by telephone number. In the “Search” box, the user has entered a particular telephone number to constitute the search query. In the “Results” box, the user has entered “Address” to limit the search results to the contact's address. In this manner, a user may obtain the address of an individual having a known telephone number. Similar to the example of FIG. 11, in this example the search query may be used to select automatic preferences as to which participant devices may receive the forwarded search query. For example, the search query may preferably be forwarded to participant devices associated with the “555” area code or closest thereto.

It will be appreciated that potential variations from the examples of FIGS. 11 and 12 are myriad and may be employed without departing from the scope of the invention. The potential combinations of queries, search results, and limit inputs are extensive. In addition, the initial user may select which participant devices may receive the search query to provide the second level search, or the system may select participant devices based on favorites lists, defined categories (e.g., friends, family, doctors, etc.), or by other means. The participants also need not be individuals, but may be businesses, government office, or other entities. Such entities may link their substantial directories into the system to provide for enhanced results. Other variations may be employed.

Referring again to FIG. 2, the mobile telephone 10 may include a primary control circuit 41 that is configured to carry out overall control of the functions and operations of the mobile telephone 10. The control circuit 41 may include a processing device 42, such as a CPU, microcontroller or microprocessor. Among their functions, to implement the features of the present invention, the control circuit 41 and/or processing device 42 may comprise a controller that may execute program code embodied as the contact information look-up application 43. The application 43, when executed by the controller, may perform device functions associated with the present invention. The controller may comprise a user controller for performing the specific functions of the user electronic device from which the search query is initiated, and/or may comprise a participant controller for performing the specific functions of the participant electronic devices that receive the search query. It will be apparent to a person having ordinary skill in the art of computer programming, and specifically in application programming for mobile telephones, servers or other electronic devices, how to program a mobile telephone and/or application server to operate and carry out logical functions associated with contact information look-up application 43. Accordingly, details as to specific programming code have been left out for the sake of brevity. Also, while the code may be executed by controller circuits 41 in accordance with exemplary embodiments, such controller functionality could also be carried out via dedicated hardware, firmware, software, or combinations thereof, without departing from the scope of the invention.

Also referring again to FIG. 2, additional features of the mobile telephone 10 will now be described. For the sake of brevity, generally conventional features of the mobile telephone 10 will not be described in great detail herein.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method. A media player 63 within the mobile telephone may be used to a play a audiovisual files stored in memory or streamed over a network.

The mobile telephone 10 also may include a local wireless interface 66, such as an infrared transceiver and/or an RF adaptor (e.g., a Bluetooth adapter), for establishing communication with an accessory, another mobile radio terminal, a computer or another device. For example, the local wireless interface 66 may operatively couple the mobile telephone 10 to a headset assembly (e.g., a PHF device) in an embodiment where the headset assembly has a corresponding wireless interface.

The mobile telephone 10 also may include an I/O interface 56 that permits connection to a variety of I/O conventional I/O devices. One such device is a power charger that can be used to charge an internal power supply unit (PSU) 58. The mobile telephone also may include a position data receiver 66, such as a GPS position data receiver.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising:
an input device; and
a controller, wherein the controller is configured to receive a contact search query from the input device and transmit the search query to at least one other electronic device, and the controller is further configured to receive contact information satisfying the search query from at least one other electronic device.

2. The electronic device of claim 1, wherein the controller is configured to transmit the contact search query to a plurality of other electronic devices and receive the contact information from one or more of the plurality of other electronic devices.

3. The electronic device of claim 1 further comprising an address book containing contact information for at least one contact, and the controller is further configured to search the address book to determine whether a contact within the address book satisfies the contact search query, and if no such contact is found, transmit the contact search query to the at least one other electronic device.

4. The electronic device of claim 3, wherein the controller is further configured to receive a contact search query from at least one other electronic device and search the address book to determine whether a contact satisfies the received search query; and
wherein if the controller determines that a contact satisfies the received search query, the controller is further configured to transmit the contact information to the electronic device that sent the received search query, and wherein if the controller determines that no contact satisfies the received search query, the controller is further configured to transmit the received search query to at least one additional electronic device.

5. The system of claim 4, wherein the address book includes an associated URL (Uniform Resource Locator) to provide an identifier for receiving a search query or contact information satisfying a search query.

6. The electronic device of claim 1, wherein the electronic device is a mobile telephone.

7. A contact information look-up system comprising:
a user electronic device comprising an input device and a user controller, wherein the user controller is configured to receive a contact search query from the input device and transmit the search query to at least one participant electronic device; and
the at least one participant electronic device comprises an address book containing contact information for at least one contact and a participant controller, wherein the participant controller is configured to receive the search query from the user electronic device and search the address book to determine whether a contact satisfies the search query; and
wherein if the participant controller determines that a contact satisfies the search query, the participant controller is further configured to transmit the contact information to the user electronic device, and wherein if the participant controller determines that no contact satisfies the search query, the participant controller is further configured to transmit the search query to at least one other participant electronic device.

8. The system of claim 7, wherein the user electronic device further comprises a user address book containing contact information for at least one contact, and the user controller is further configured to search the user address book to determine whether a contact within the user address book satisfies the search query.

9. The system of claim 7, wherein each address book includes an associated URL (Uniform Resource Locator) to provide an identifier for receiving the search query.

10. The system of claim 7, wherein the user controller is configured to transmit the search query to a plurality of participant electronic devices.

11. The system of claim 10, wherein if the participant controllers of the plurality of participant electronic devices determine that no contact satisfies the search query, the participant controllers are further configured to transmit the search query to a plurality of other participant electronic devices.

12. The system of claim 11, wherein the participant electronic devices comprise a plurality of search levels, wherein each participant electronic device is at a search level based on the number of times the search query has been forwarded in a pathway from the user electronic device to the participant electronic device, and the number of search levels is limited to a fixed number.

13. The system of claim 7, wherein the user electronic device is a mobile telephone.

14. The system of claim 7, wherein each participant electronic device is a mobile telephone.

15. A method of obtaining contact information with a user electronic device comprising the steps of:
inputting a search query into the user electronic device;
forwarding the search query to at least one participant electronic device having an address book containing contact information for at least one contact;
searching the address book to determine whether a contact satisfies the search query; and
if a contact satisfies the search query, transmitting the contact information to the user electronic device; else
if no contact satisfies the search query, forwarding the search query to at least one other participant electronic device.

16. The method of claim 15 further comprising displaying the contact information for a contact that satisfies the search query.

17. The method of claim 15, wherein the user electronic device has a user address book containing contact information for at least one contact, and the method further comprises searching the user address book to determine whether a contact satisfies the search query.

18. The method of claim 15, wherein the search query is forwarded from the user electronic device to a plurality of participant electronic devices.

19. The method of claim 18, wherein if a search of the address book of each participant electronic device determines that no contact satisfies the search query, then each participant electronic device forwards the search query to a plurality of other participant electronic devices.

20. The method of claim 19, wherein each participant electronic device is at a search level based on the number of times the search query has been forwarded between the user electronic device and the participant electronic device, the method further comprising terminating the search after the search query has been forwarded over a specific number of search levels.

21. The method of claim 19, wherein the steps of forwarding the search query include adding pathway information indicating the transmission pathway of the search query from the user electronic device to a participant electronic device.

22. The method of claim 21, wherein the step of transmitting the contact information to the user electronic device includes transmitting the contact information along a reverse pathway from the participant electronic device containing the contact information to the user electronic device.

23. The method of claim 22, wherein the step of transmitting the contact information to the user electronic device includes removing the pathway information as the contact information is transmitted along the reverse pathway.

24. The method of claim 15, wherein each address book includes an associated URL (Uniform Resource Locator) to provide an identifier for receiving the search query, and the steps of forwarding the search query comprise forwarding the search query based on the address book URLs.

25. The method of claim 15, wherein the step of inputting the search query comprises entering search criteria to limit the contact information received from a participant electronic device.
